(19) United States
(12) Patent Application Publication
(10) Pub. No.: US 2014/0055468 A1
(43) Pub. Date: Feb. 27, 2014

(54) INFORMATION PROCESSING APPARATUS

(71) Applicant: SONY CORPORATION, Tokyo (JP)

(72) Inventors: TAKAHIRO TOMITA, Nagano (JP); YASUNORI KIMURA, Nagano (JP); KEN SHIMIZU, Nagano (JP)

(73) Assignee: SONY CORPORATION, Tokyo (JP)

(21) Appl. No.: 13/966,548

(22) Filed: Aug. 14, 2013

(30) Foreign Application Priority Data
Aug. 24, 2012 (JP) 2012-184850

(51) Int. Cl. G09G 5/00

(52) U.S. Cl. CPC G09G 5/005
USPC 345/520

(57) ABSTRACT

An information processing apparatus includes a substantially plate-like display unit having at least a display, a substantially plate-like main unit having at least a keyboard, a connecting plate adapted to connect the display unit and the main unit via hinges, and a flat coaxial cable including at least one coaxial cable that transmits RF signals between the display unit and the main unit, the at least one coaxial cable being wrapped and shaped flat by a wrapper and secured at predetermined positions in the display unit and the main unit.

### BACKGROUND

The present technology relates to an information processing apparatus, and in particular to an information processing apparatus that enables the transmission of radio frequency (RF) signals from a main unit to a display unit.

In portable personal computers substantially referred to as the notebook PC, a clamshell-type structure is adopted in which a display housing is flipped up and down with respect to a keyboard about a hinge serving as the pivoting point (see Japanese Unexamined Patent Application Publication No. 2003-37655, paragraphs 0002 to 0005, for example).

In some clamshell-type notebook PCs, an antenna for a wireless local area network (WLAN) or the like is provided in the display housing to keep the antenna away from the CPU and other noise sources. In this case, coaxial cables 1 for transmitting RF signals are extended through the shaft of a hinge 2, for example, as shown in FIG. 1, to connect the antenna in the display housing 3A to the radio module in the keyboard housing 3B. In FIG. 1, the three coaxial cables 1a to 1c are extended through the shaft of the hinge 2.

Along with the rapidly spreading use of tablet terminals in recent years, the so-called convertible (transformable) tablet PCs that are also usable as tablet-style PCs have appeared.

FIGS. 2A to 2C illustrate an example of operation mechanism of a convertible tablet PC 11 (referred to hereinafter simply as the tablet PC 11).

FIG. 2A illustrates the tablet PC 11 being used in the tablet mode.

The tablet PC 11 includes a display unit 12 and a main unit 13. In the tablet mode, the display unit 12 and the main unit 13 are stacked in the form of a single thin plate.

One surface of the display unit 12 accommodates a display 14 including a liquid crystal display (LCD), electro luminescence (EL) display, or the like. The upper surface of the display 14 accommodates a touch panel through which the user can input desired information by touching (tapping) the screen of the display 14 with a finger or stylus pen. The main unit 13 includes a central processing unit (CPU), a storage device (not shown), and so on.

When the display unit 12 in the tablet mode illustrated in FIG. 2A is slid backward as illustrated in FIG. 2B, the keyboard 15 disposed in the upper surface of the main unit 13 appears.

When the slid display unit 12 is raised (tilted) toward the operating user (near side) as illustrated in FIG. 2C, the tablet PC 11 becomes like a clamshell-type PC in the past.

Even in such a tablet PC 11, it is desirable to dispose in the main unit 13 the radio module that controls wireless LAN communications and dispose the antenna in the display unit 12 to keep the antenna away from the CPU and other noise sources.

### SUMMARY

If the radio module is disposed in the main unit 13 and the antenna is disposed in the display unit 12, it is difficult to ensure the durability of cables in such a slide and tilt mechanism as described above, because the cables that connect the display unit 12 to the main unit 13 are repeatedly bent in substantially all parts thereof due to sliding motions.

A structure having both the radio module and the antenna disposed in either the display unit 12 or the main unit 13 is therefore adopted in tablet PCs 11 having a slide and tilt mechanism as in FIGS. 2A to 2C.

The structure having both the radio module and the antenna disposed in the display unit 12 involves a problem in that the display unit 12 is enlarged in size and thickness. This structure involves another problem in that available radio modules are limited because the circuit in the display unit 12 is connected to the circuit in the main unit 13 via a universal serial bus (USB) or the like.

On the other hand, the structure having both the radio module and the antenna disposed in the main unit 13 involves a problem in that the radio characteristics are affected because the antenna is disposed near the CPU and other noise sources.

As described above, in an apparatus such as the convertible tablet PC including a display unit and a main unit, it has been difficult to transmit RF signals (high frequency signals) such as wireless LAN radio communication signals from the main unit to the display unit.

The structure having cables extended through the hinge shaft as illustrated in FIG. 1 involves a problem in that the size and thickness of the apparatus as a whole may not be reduced due to an enlarged shaft diameter of the hinge and the location of the hinge mechanism may significantly be restricted due to the positional relationship with the cables.

It is desirable to enable the transmission of RF signals from the main unit to the display unit.

An information processing apparatus according to an embodiment of the present technology includes a substantially plate-like display unit having at least a display, a substantially plate-like main unit having at least a keyboard, a connecting plate that connects the display unit and the main unit via hinges, and a flat coaxial cable including at least one coaxial cable that transmits RF signals between the display unit and the main unit, the at least one coaxial cable being wrapped and shaped flat by a wrapper and being secured at predetermined positions in the display unit and the main unit.

In this embodiment of the present technology, the substantially plate-like display unit having at least a display and the substantially plate-like main unit having at least a keyboard are connected by the connecting plate via hinges and the flat coaxial cable including the at least one coaxial cable that is wrapped and shaped flat by the wrapper and transmits RF signals between the display unit and the main unit is secured at predetermined positions in the display unit and the main unit.

An information processing apparatus according to another embodiment of the present technology includes a substantially plate-like display unit having at least a display, a substantially plate-like main unit having at least a keyboard, and a coaxial cable that transmits RF signals between the display unit and the main unit, the coaxial cable being secured at predetermined positions in the display unit and the main unit without being routed through a connecting portion including hinges that connect the display unit and the main unit.

In this embodiment of the present technology, the substantially plate-like display unit having at least a display and the substantially plate-like main unit having at least a keyboard are provided and the coaxial cable that transmits RF signals between the display unit and the main unit is secured at predetermined positions in the display unit and the main unit without being routed through the connecting portion including hinges that connect the display unit and the main unit.

According to the embodiments of the present technology, RF signals can be transmitted from the main unit to the display unit.

### BRIEF DESCRIPTION OF THE DRAWINGS

FIG. 1 illustrates an example of configuration of a clamshell-type notebook PC in the past;

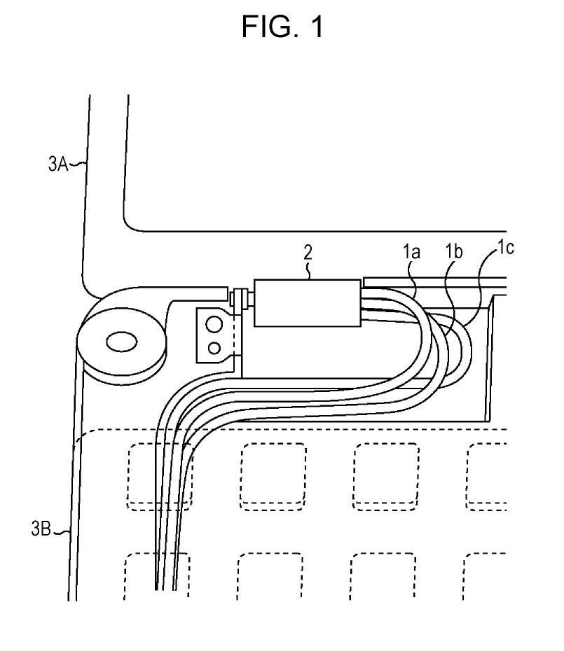

FIGS. 2A to 2C illustrate an example of configuration of a tablet PC in the past;

FIGS. 3A and 3B are perspective views illustrating an exemplary structure of a tablet PC in an embodiment of the present technology;

FIGS. 4A to 4D are perspective views illustrating a tilting motion of the tablet PC in FIGS. 3A and 3B;

FIGS. 5A to 5D are side views illustrating the tilting motion of the tablet PC in FIGS. 3A and 3B;

FIG. 6 is an enlarged side view illustrating the tablet PC in FIG. 3B;

FIG. 7 is a plan view of a flat coaxial cable;

FIG. 8 is a sectional view of the flat coaxial cable;

FIG. 9 is a perspective view of a link mechanism in the tablet PC in FIGS. 3A and 3B;

FIGS. 10A and 10B are perspective views illustrating bent states of the flat coaxial cable;

FIGS. 11A and 11B are cross-sectional side views of the tablet PC in FIGS. 3A and 3B;

FIG. 12 is a perspective view illustrating an assembled state of the flat coaxial cable;

FIG. 13 is a block diagram illustrating an exemplary hardware configuration of the tablet PC in FIGS. 3A and 3B; and

FIG. 14 illustrates another application of a two-shaft hinge mechanism.

### DETAILED DESCRIPTION OF EMBODIMENTS

### [Appearance of Tablet PC]

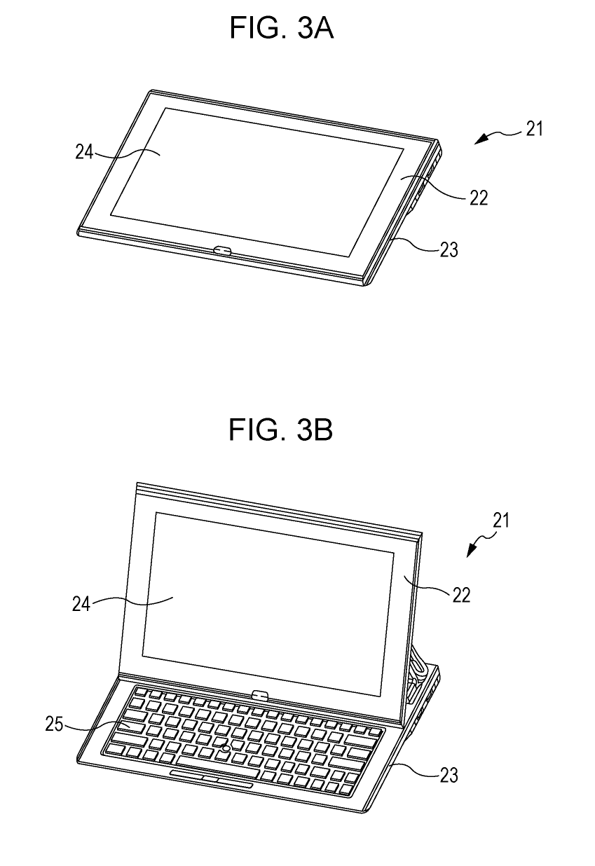

FIGS. 3A and 3B are perspective views illustrating an exemplary structure of a tablet PC in an embodiment of the present technology.

The tablet PC 21 illustrated in FIGS. 3A and 3B is a convertible (i.e., transformable) portable personal computer (PC) that can be used as a tablet PC and like a clamshell-type PC.

FIG. 3A is a perspective view of the tablet PC 21 for use as the tablet; FIG. 3B is a perspective view of the tablet PC 21 for use like a clamshell-type PC.

The tablet PC 21 includes a substantially plate-like display unit 22 and a substantially plate-like main unit 23.

When used as the tablet, the display unit 22 and the main unit 23 are stacked in the form of a single thin plate. A display 24 such as a liquid crystal display (LCD) or electro luminescence (EL) display is provided in one surface of the display unit 22.

The upper surface of the display 24 accommodates a touch panel through which the user can input desired information by touching (tapping) the screen of the display 24 with a finger or stylus pen.

The main unit 23 includes a keyboard 25, as well as a main circuit board, CPU, memory, and other storage device (all not shown) of the tablet PC 21.

When the user slides backward the near side of the substantially rectangular display unit 22 in the state illustrated in FIG. 3A, the far side of the display unit 22 is lifted and the display unit 22 rises (i.e., tilts up). Consequently, the tablet PC 21 becomes like a clamshell-type PC as illustrated in FIG. 3B and can be used as a notebook PC in the past. The keyboard 25 is disposed on the upper surface of the main unit 23 that is exposed when the display unit 22 tilts up.

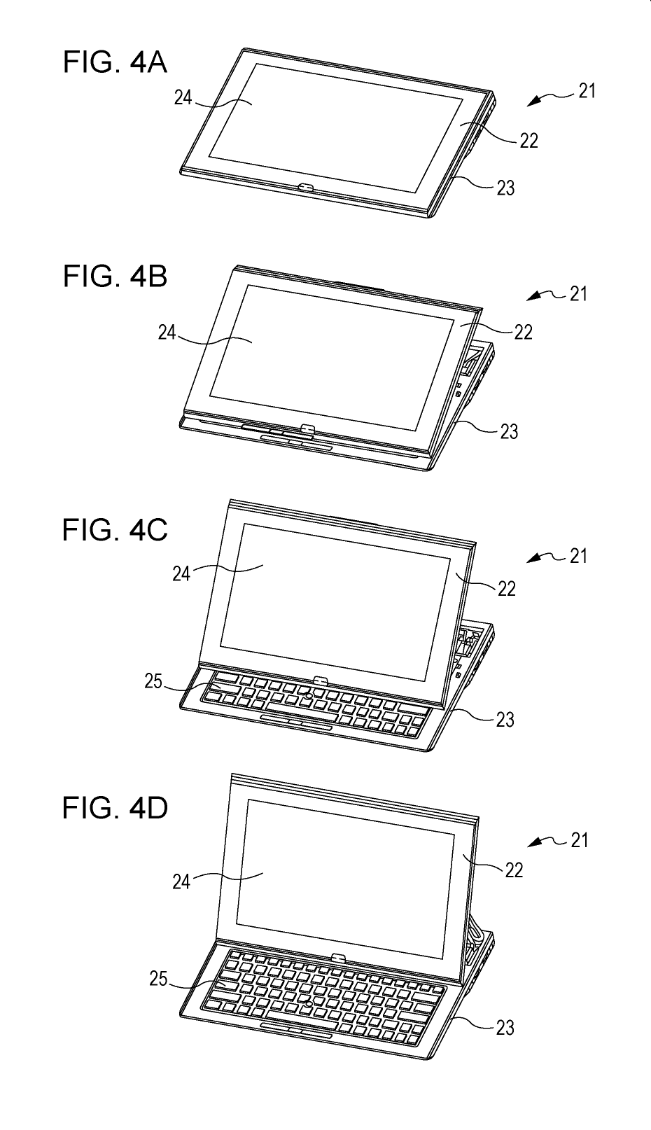

FIGS. 4A to 4D are perspective views illustrating in a step-by-step manner how the tablet PC 21 is transformed from the tablet mode in FIG. 3A to the notebook PC mode in FIG. 3B.

The tablet PC 21 can be transformed from the tablet mode in FIG. 3A to the notebook PC mode in FIG. 3B in the order of FIGS. 4A, 4B, 4C, and 4D.

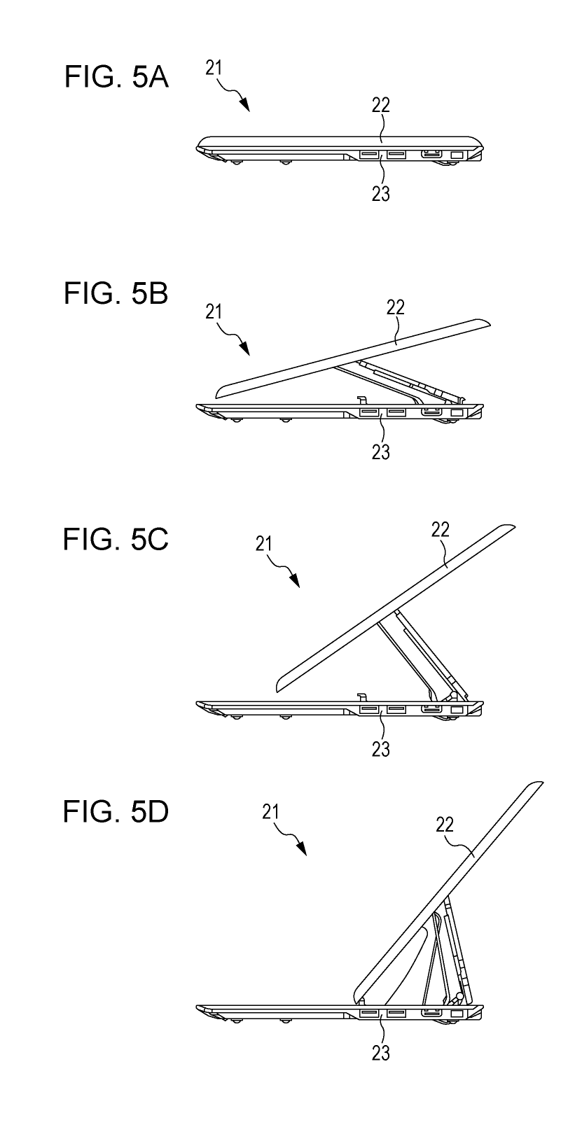

FIGS. 5A to 5D are side views illustrating the states of the tablet PC 21 in FIGS. 4A to 4D.

FIG. 5A is a side view of the state in FIG. 4A; FIG. 5B is a side view of the state in FIG. 4B; FIG. 5C is a side view of the state in FIG. 4C; and FIG. 5D is a side view of the state in FIG. 4D.

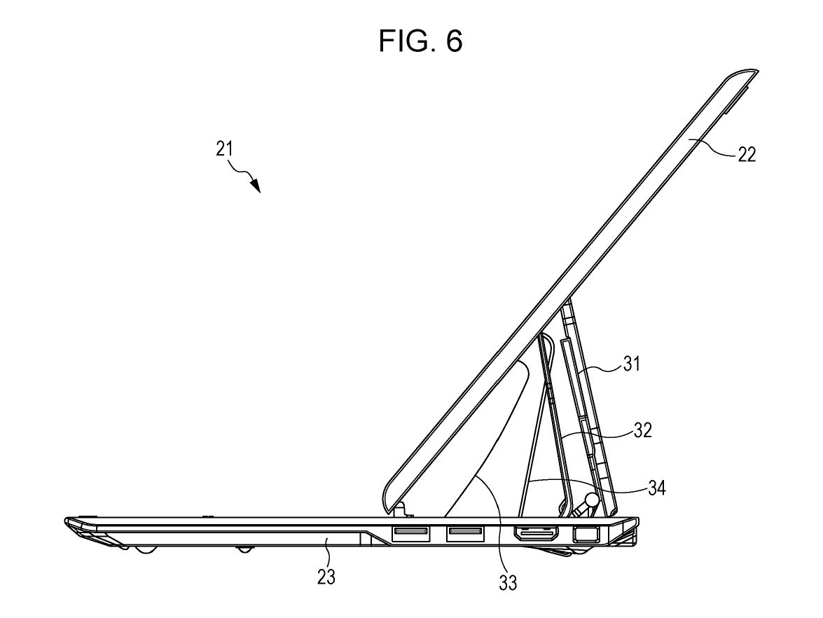

FIG. 6 is an enlarged side view illustrating the tablet PC 21 in the notebook PC mode illustrated in FIG. 5D.

The display unit 22 and the main unit 23 are mechanically connected to each other by a rear plate 31 and a guide plate 32.

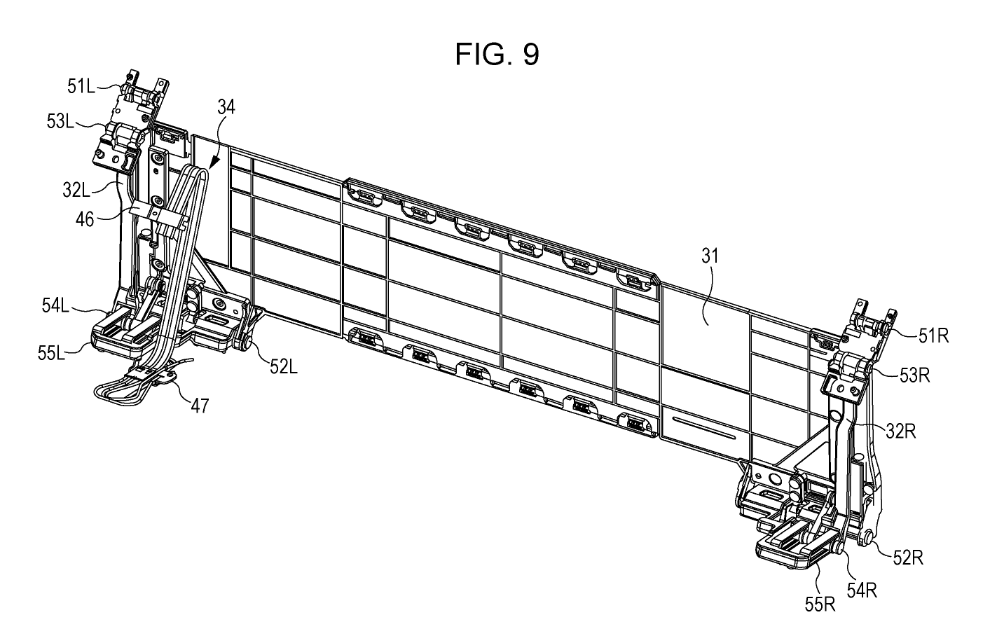

The rear plate 31 is connected to the display unit 22 and the main unit 23 by hinges (such as hinges 51R and 52R in FIG. 9) and rotatable with respect to the display unit 22 and the main unit 23. The rear plate 31 serves to connect the display unit 22 to the main unit 23.

The guide plate 32 serves to tilt (i.e., slide) the display unit 22 along a certain trajectory with respect to the main unit 23, because the rear plate 31 alone permits the display unit 22 to freely rotate with respect to the main unit 23. That is, the guide plate 32 serves to guide the tilting motion of the display unit 22.

The display unit 22 is electrically connected to the main unit 23 by flexible printed circuits (FPCs) 33 that transmit video signals (including control signals) supplied to the display 24 and a flat coaxial cable 34 that transmits RF signals (i.e., high frequency signals).

### [Structure of Flat Coaxial Cable 34]

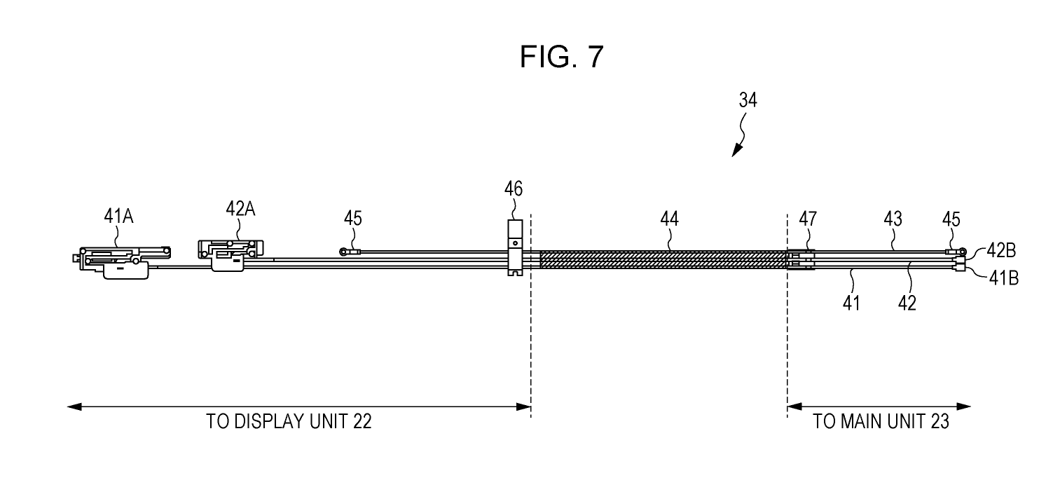

FIG. 7 is a plan view of the flat coaxial cable 34 viewed alone.

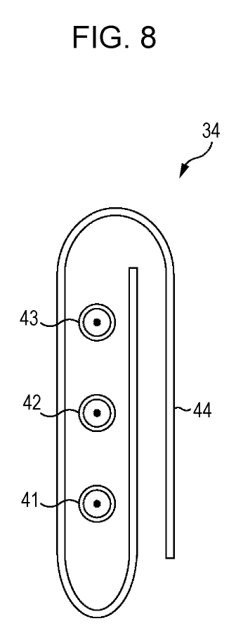

The flat coaxial cable 34 includes three coaxial cables 41 to 43. As illustrated in the cross-sectional view in FIG. 8, the three coaxial cables 41 to 43 are arranged in a row and shaped flat and fixed by an adhesive insulating tape 44. The insulating tape 44 is an example of wrapper that shapes flat and fixes the row of coaxial cables 41 to 43. The wrapper is not limited thereto and may be made of another thin and flexible material.

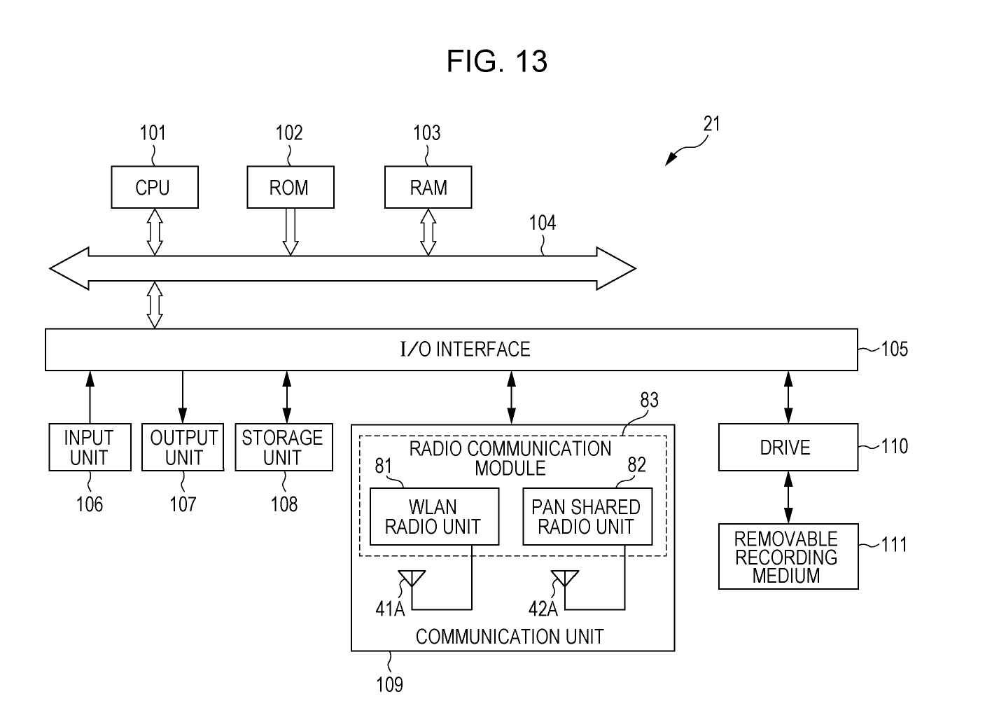

The coaxial cable 41 is equipped with a main antenna 41A at an end thereof toward the display unit 22 and a connector 41B on the other end toward the main unit 23. The connector 41B is connected to a radio communication module 83 (FIG. 13) in the main unit 23. The coaxial cable 41 transmits RF signals between the radio communication module 83 in the main unit 23 and the main antenna 41A in the display unit 22.

The coaxial cable 42 is equipped with a sub-antenna 42A at an end thereof toward the display unit 22 and a connector 42B at the other end thereof toward the main unit 23. The connector 42B is connected to the radio communication module 83. The coaxial cable 42 transmits RF signals between the radio communication module 83 in the main unit 23 and the sub-antenna 42A in the display unit 22.

The RF signals transmitted through the coaxial cables 41 and 42 are radio communication signals at a frequency range of approximately 2 to 5 GHz sent as radio waves through a wireless LAN as described later with reference to FIG. 13. If signal cables other than coaxial cables are used as the RF signal transmission media, their high resistance values at high frequencies (at 5 GHz in particular) would substantially weaken high frequency signals.

If FPCs are used to transmit RF signals, a phenomenon may arise in which radio communications are enabled in the notebook PC mode but not in the tablet mode, because the FPCs are thin and their performance widely varies when bent. For these reasons, coaxial cables are suitable as the RF signal transmission media.

The coaxial cable 43 is used as the ground (GND) wire to reinforce the ground in the display unit 22 and is equipped with lug terminals 45 at both ends thereof.

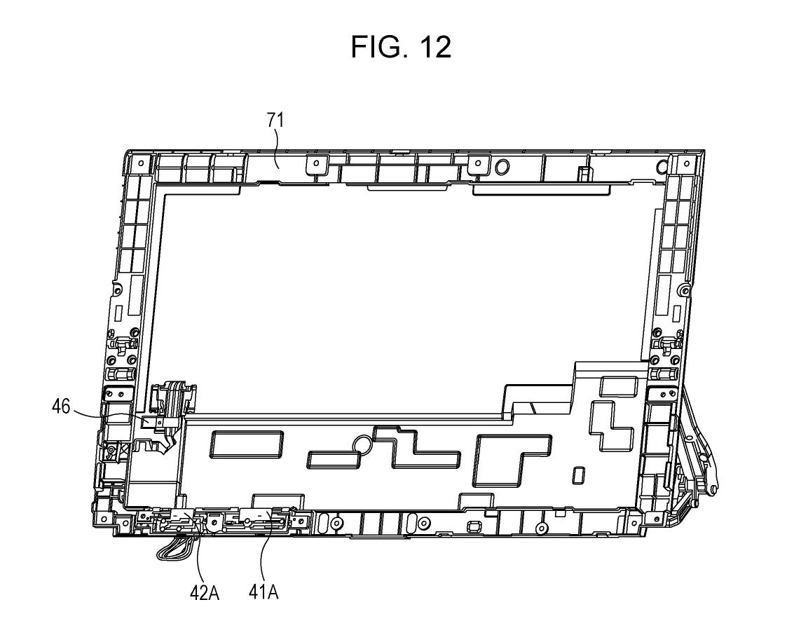

A display-side metal fixture 46 is attached to an end of the insulating tape 44 toward the display unit 22 to secure the flat coaxial cable 34 to the housing 71 of the display unit 22 (FIG. 12).

A main unit-side metal fixture 47 is attached to the other end of the insulating tape 44 toward the main unit 23 to secure the flat coaxial cable 34 to the housing (not shown) of the main unit 23.

The three coaxial cables 41 to 43 arranged in a flat row are secured (i.e., fixedly attached) to the display-side metal fixture 46 by solder, for example. The three coaxial cables 41 to 43 are also secured to the main unit-side metal fixture 47 in the same way.

The display-side metal fixture 46 and the main unit-side metal fixture 47 are separated from each other by a predetermined spacing (distance).

### [Tilting Motion and how to Secure Cable]

Referring next to FIGS. 9 to 12, the tilting motion of the display unit 22 and how to secure the flat coaxial cable 34 will be described.

FIG. 9 is a perspective view of a link mechanism in the tablet PC 21.

In FIG. 9, components of the same type symmetrically provided on the left and right side viewed from the front of the tablet PC 21 are designated by the same reference numerals followed by different characters, i.e., L for the left-side components and R for the right-side components. Description of these components will be given referring only to one of the left- and right-side components, omitting description of the other one as appropriate, indicating only their reference characters in parentheses.

The rear plate 31 is rotatably connected to the display unit 22 via hinges 51R and 51L and is rotatably connected to the main unit 23 via hinges 52R and 52L. The rear plate 31 has, therefore, two-shaft hinges including the hinges 51R and 51L for connection with the display unit 22 and the hinges 52R and 52L for connection with the main unit 23.

The guide plate 32R (32L) is rotatably connected to the display unit 22 via a hinge 53R (53L) located toward the display unit 22 and is connected to the main unit 23 via a hinge 54R (54L).

The hinge 54R (54L) of the guide plate 32R (32L) toward the main unit 23 is guided by a slide guide 55R (55L) so as to slide forward and backward. The slide guide 55R (55L) is a component of the main unit 23. Here, the forward and backward directions refer to the directions toward the front and back of the tablet PC 21 when viewed from the front thereof.

When the tablet PC 21 is used in the tablet mode, in other words, when the display unit 22 is in close contact with the main unit 23 as illustrated in FIGS. 4A and 5A, the hinge 54R (54L) of the guide plate 32R (32L) is located at the forward end in the slide guide 55R (55L).

As the display unit 22 is raised (tilts up) in the order of FIGS. 4A and 5A, FIGS. 4B and 5B, FIGS. 4C and 5C, and FIGS. 4D and 5D, the hinge 54R (54L) of the guide plate 32R (32L) moves backward in the slide guide 55R (55L) and reaches the backward end in the notebook PC mode illustrated in FIGS. 4D and 5D.

The flat coaxial cable 34 is secured to the display unit 22 near the left guide plate 32L by the display-side metal fixture 46 and to the main unit 23 by the main unit-side metal fixture 47.

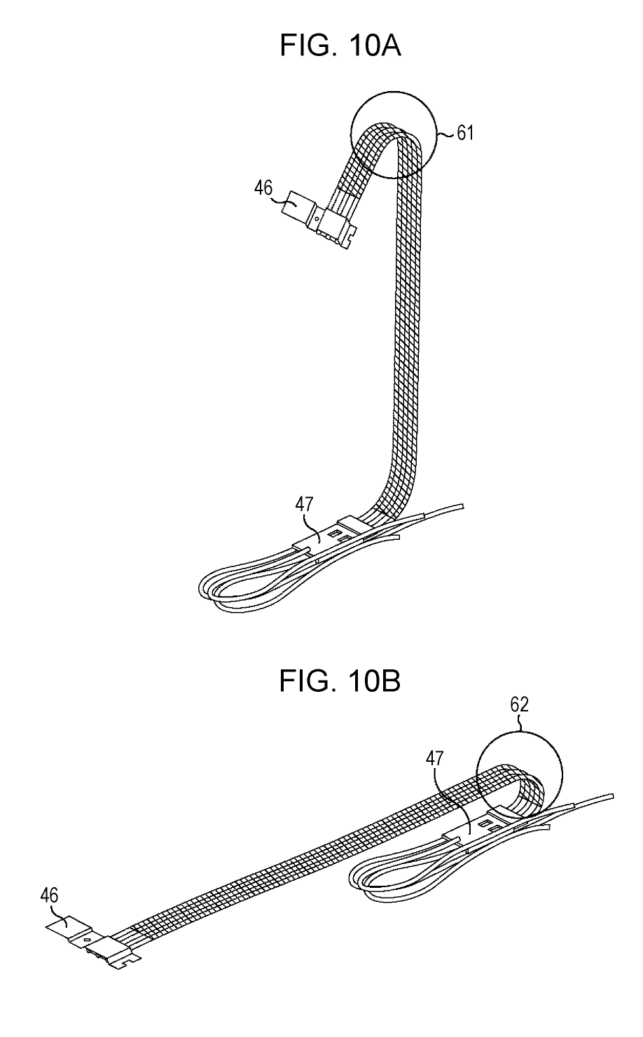

FIG. 10A is a perspective view illustrating a bent state of the flat coaxial cable 34 when the tablet PC 21 is in the notebook PC mode (FIGS. 4D and 5D); FIG. 10B is a perspective view illustrating a bent state of the flat coaxial cable 34 when the tablet PC 21 is in the tablet mode (FIGS. 4A and 5A).

In FIG. 9 and FIGS. 10A and 10B, end portions of the flat coaxial cable 34 beyond the display-side metal fixture 46 and the main unit-side metal fixture 47 are partially omitted.

When the tablet PC 21 is in the notebook PC mode, the flat coaxial cable 34 folds only at the bending point 61 encircled in FIG. 10A.

When the tablet PC 21 is in the tablet mode, the flat coaxial cable 34 folds only at the bending point 62 encircled in FIG. 10B.

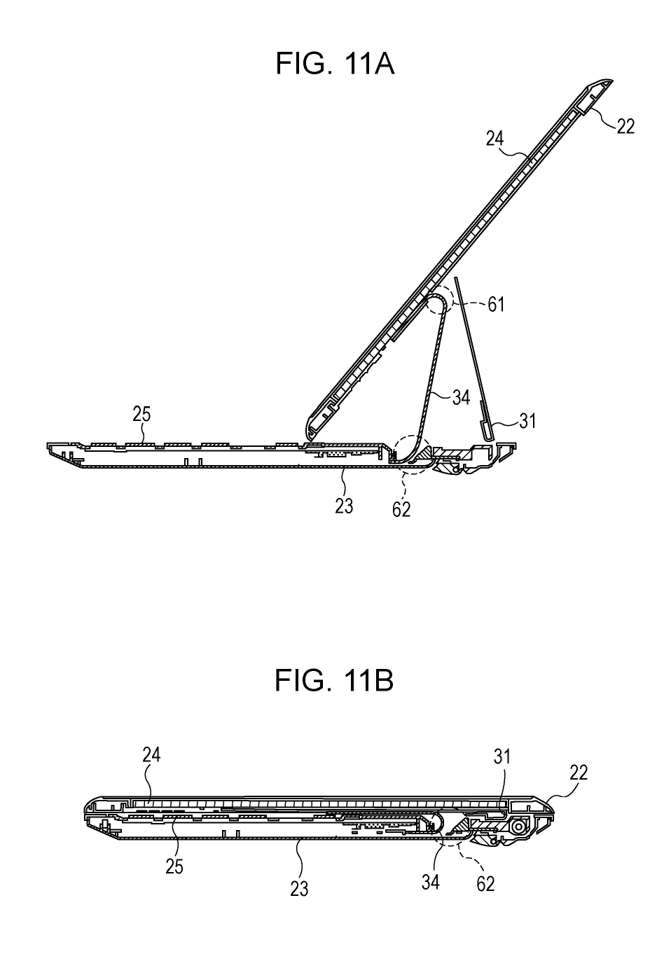

FIGS. 11A and 11B are cross-sectional side views of the tablet PC 21. More specifically, FIG. 11A is a cross-sectional side view of the tablet PC 21 in the notebook PC mode corresponding to FIG. 10A; FIG. 11B is a cross-sectional side view of the tablet PC 21 in the tablet mode corresponding to FIG. 10B.

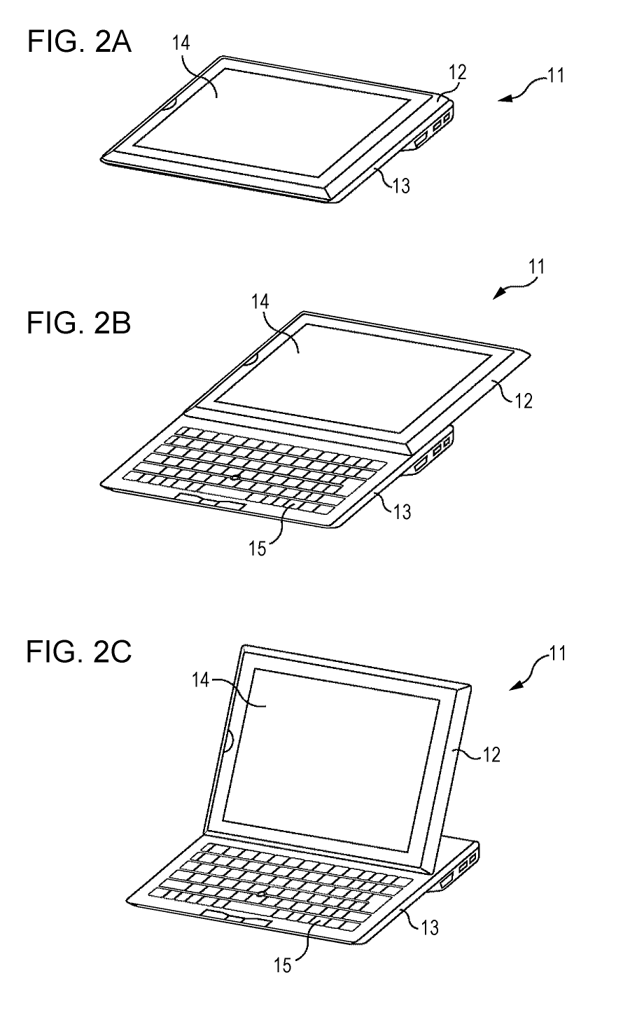

In the slide and tilt mechanism illustrated in FIGS. 2A to 2C, the cables are bent (folded) at many points as the display unit 22 slides.

In contrast, the combination of the link mechanism and the flat coaxial cable 34 in the tablet PC 21 causes the flat coaxial cable 34 to bend (fold) only at two bending points 61 and 62 and thereby improves the durability of the cable.

Furthermore, in the slide and tilt mechanism illustrated in FIGS. 2A to 2C, the bending points of the FPCs or cables are inevitably located between the display unit 12 and the main unit 13. It has been necessary to ensure a space between the display unit 12 and the main unit 13, because, if the radius of these bending points is reduced to limit the total thickness of the apparatus, the durability of the cables against bending would be affected. There is a limit, therefore, in reducing the total thickness of the apparatus.

In contrast, in the combination of the link mechanism and the flat coaxial cable 34 in the tablet PC 21, it is possible to increase the radius of the bending point 61, because the bending point 61 of the flat coaxial cable 34 is flat in the tablet mode and therefore the radius of the bending point 61 does not influence the total thickness of the apparatus.

The flat coaxial cable 34 includes three coaxial cables 41 to 43 shaped flat and fixed by the insulating tape 44 serving as the wrapper. If the three coaxial cables 41 to 43 are left loose, the tilting motion of the display unit 22 may cause the cables to cross each other or move from side to side.

The flat coaxial cable 34 can restrict the movement of individual coaxial cables 41 to 43 by shaping flat and fixing these three coaxial cables 41 to 43 with the insulating tape 44.

The flat coaxial cable 34 is secured to the housing 71 of the display unit 22 (FIG. 12) by the display-side metal fixture 46 and to the housing (not shown) of the main unit 23 by the main unit-side metal fixture 47. That is, the flat coaxial cable 34 is positioned with respect to the display unit 22 by the display-side metal fixture 46 and with respect to the main unit 23 by the main unit-side metal fixture 47.

This prevents the flat coaxial cable 34 from moving within the display unit 22 and within the main unit 23 when the display unit 22 is tilted.

FIG. 12 is a perspective view illustrating the flat coaxial cable 34 assembled to the housing 71 of the display unit 22.

In FIG. 12, the flat coaxial cable 34 is secured to the housing 71 of the display unit 22 by the display-side metal fixture 46 and the main antenna 41A and sub-antenna 42A are also secured to the housing 71 of the display unit 22.

The display-side metal fixture 46, main antenna 41A, and sub-antenna 42A are secured to the housing 71 by claws, screws, or the like.

### [Exemplary Hardware Configuration of Tablet PC 21]

FIG. 13 is block diagram illustrating an exemplary hardware configuration of the tablet PC 21.

In the tablet PC 21, a central processing unit (CPU) 101, read only memory (ROM) 102, and random access memory (RAM) 103 are interconnected via a bus 104.

An I/O interface 105 is also connected to the bus 104. An input unit 106, output unit 107, storage unit 108, communication unit 109, and drive 110 are connected to the I/O interface 105.

The input unit 106 includes a keyboard 25, a touch panel, a microphone, and the like. The output unit 107 includes a display 24, a loudspeaker, and the like. The storage unit 108 includes a hard disk, a non-volatile memory, and the like. The communication unit 109 includes a network interface to a wireless local area network (WLAN) or other network. The drive 110 drives a removable recording medium 111 such as a magnetic disk, optical disk, magneto-optical disk, or semiconductor memory.

The communication unit 109 is equipped with a main antenna 41A and a WLAN radio unit 81 that controls communications through a wireless LAN (WLAN) in conformance with the so-called Wi-Fi standards including IEEE 802.11b, IEEE 802.11g, and IEEE 802.11n defined by the institute of electrical and electronic engineers (IEEE).

The communication unit 109 also includes a sub-antenna 42A and a PAN shared radio unit 82 that controls both the communications through the wireless LAN in conformance with IEEE 802.11b, IEEE 802.11g, IEEE 802.11n, and other standards and the Bluetooth communications through a personal area network (PAN).

The WLAN radio unit 81 establishes, via the main antenna 41A, radio communications with other radio communication apparatus serving as access points by sending and receiving radio waves (radio communication signals) in the 2.4 or 5 GHz band.

The PAN shared radio unit 82 establishes, via the sub-antenna 42A, radio communications with other radio communication apparatus serving as access points by sending and receiving radio waves (radio communication signals) in the 2.4 or 5 GHz band. The PAN shared radio unit 82 can also establish Bluetooth communications using radio waves (radio communication signals) in the 2.4 GHz band.

As described above, the main antenna 41A and sub-antenna 42A are disposed in the display unit 22, while the WLAN radio unit 81 and PAN shared radio unit 82 are disposed as the radio communication module 83 in the main unit 23.

The radio communication module 83 can establish radio communications according to the multi input multi output (MIMO) specifications in IEEE 802.11n when establishing radio communications in conformance with IEEE 802.11n. More specifically, the radio communication module 83 can simultaneously send or receive two halves of the data to be sent or received via the main antenna 41A and the sub-antenna 42A. This theoretically doubles the communication speed and thus increases the communication speed.

The communication unit 109 can also establish Bluetooth communications using the PAN shared radio unit 82 and sub-antenna 42A.

The radio communication module 83 is connected to the main antenna 41A and sub-antenna 42A by the flat coaxial cable 34 as illustrated in FIG. 7.

In the tablet PC 21 configured as described above, the CPU 101 loads the operating system (OS) and browser and other application programs from the storage unit 108, for example, via the I/O interface 105 and bus 104, to the RAM 103 and executes these programs.

In the tablet PC 21, programs such as the OS and application programs can be installed into the storage unit 108 via the I/O interface 105 when a removable recording medium 111 is mounted in the drive 110. The programs can also be received by the communication unit 109 via a wired or wireless transmission medium such as a local area network, the Internet, and digital satellite broadcast and installed into the storage unit 108. Alternatively, the programs may be preinstalled in the ROM 102 and/or storage unit 108.

Although the communication unit 109 has functions for both wireless LAN and Bluetooth communications in the embodiment described above, the tablet PC 21 may have a PAN radio communication function other than Bluetooth®, such as Zigbee® or ultra wide band (UWB).

The tablet PC 21 may further have a radio communication function for a wide area network (WAN) using a mobile communication network.

As described above, in the tablet PC 21, the flat coaxial cable 34 including the three coaxial cables 41 to 43 shaped flat is adopted to connect the radio communication module 83 in the main unit 23 to the main antenna 41A and sub-antenna 42A in the display unit 22.

This can achieve a configuration having the main antenna 41A and sub-antenna 42A disposed in the display unit 22 and the radio communication module 83 disposed in the main unit 23.

The main antenna 41A and sub-antenna 42A can be located at a higher position than in the main unit 23 and kept away from the main board in the main unit 23 on which the CPU or other noise sources are mounted and the radio characteristics can thereby be improved.

Unlike tablet PCs in the past in which both the radio module and the antenna are disposed in the display unit, it is not necessary to use a special module as the radio communication module 83 in the tablet PC 21.

If the antenna is inevitably disposed in the main unit and a metal housing is adopted as the outer housing (outer cover) for strength and appearance of the main unit, it would be necessary to cut out the metal housing at an area corresponding to the antenna. In contrast, in the tablet PC 21, in which the antennas (main antenna 41A and sub-antenna 42A) can be disposed in the display unit 22, it is not necessary to cut out the housing, which is advantageous in terms of appearance and strength.

If the antennas are disposed in the main unit, the locations of the external connectors and battery would be restricted. In contrast, in the tablet PC 21 having the antennas disposed in the display unit 22 in which the external connectors and battery are not disposed, the freedom of design of the main unit 23 is enhanced.

Although the flat coaxial cable 34 includes the three coaxial cables 41 to 43 including the GND wire in the above embodiment, the number of coaxial cables may be increased or decreased as necessary. It is necessary, however, to shape flat and fix the one or more coaxial cables using a wrapper (insulating tape 44 in the above embodiment) to restrict the movement of individual coaxial cables.

Although, in the above embodiment, the flat coaxial cable 34 is disposed on the left side of the main unit viewed from the front thereof as shown in FIG. 9, the flat coaxial cable 34 may be disposed at any position in the widthwise direction.

Although, in the above embodiment, the width (length in the widthwise direction) of the rear plate 31 matches the total width of the tablet PC 21, the width of the rear plate 31 can arbitrarily be dimensioned considering the design and other factors of the tablet PC 21. In other words, the hinges 51R and 51L and hinges 52R and 52L that secure the rear plate 31 to the display unit 22 and main unit 23 and the guide plates 32R and 32L can be located at any positions in the widthwise direction depending on the width of the rear plate 31, without being limited to the positions in this embodiment.

Although, in the above embodiment, the signal lines connecting between the display unit 22 and the main unit 23 are classified into two types, i.e., flat coaxial cable 34 and FPC 33, the number of coaxial cables may be increased to transmit all the signals through the flat coaxial cable 34.

### [Another Application of Two-Shaft Hinge Mechanism]

The structure adopted for the tablet PC 21 described above includes the combination of the two-shaft hinge mechanism (link mechanism) including hinges 51 and 52 that connect the rear plate 31 to the display unit 22 and main unit 23 and the flat coaxial cable 34 including the coaxial cables 41 to 43 shaped flat.

The two-shaft hinge mechanism and the flat coaxial cable 34 used in the tablet PC 21 are not limited to this combination. For example, as in clamshell-type PCs in the past, it is possible to combine a structure having coaxial cables extended to the display unit through the hinge shafts (hinges 52R and 52L) of the two-shaft hinge mechanism described above.

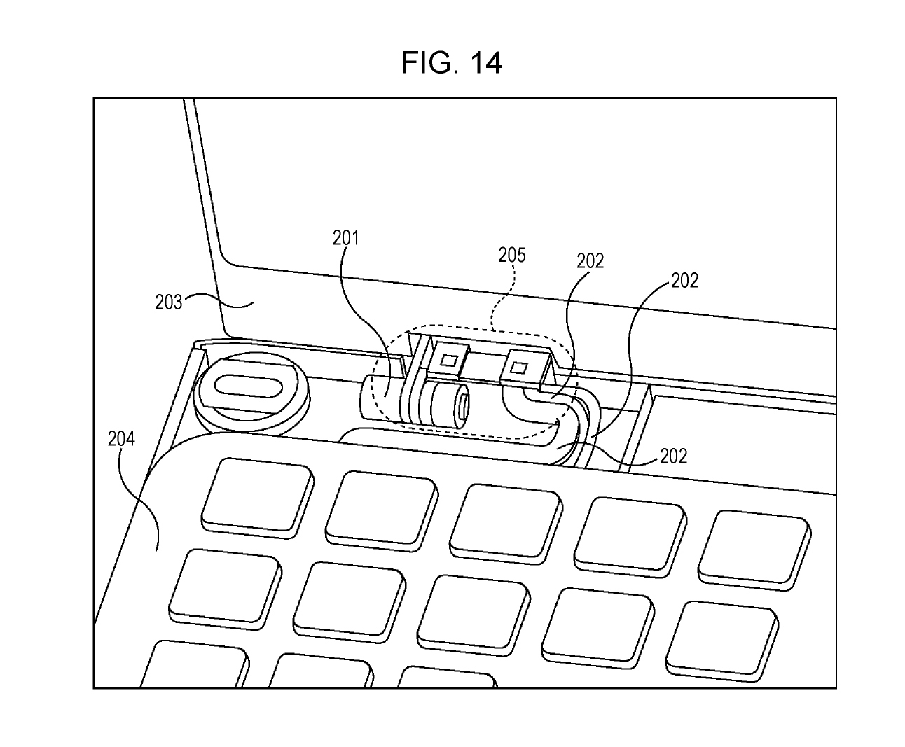

If a plurality of coaxial cables 202 are extended beside a hinge 201, for example, as shown in FIG. 14, the width of the connecting portion 205 that connects the display unit 203 and the main unit 204 would be increased and the width of the tablet PC would be increased accordingly.

If a plurality of coaxial cables 202 are extended through the shaft of the hinge 201, the shaft diameter of the hinge 201 would be enlarged and the thickness of the apparatus would be increased accordingly.

If the number of coaxial cables 202 is increased as radio communication functions such as WAN radio communication functions increase, in addition to the functions for wireless LAN and Bluetooth communications, the reduction in thickness and size of the apparatus would be more difficult.

By adopting a structure in which the coaxial cables that transmit RF signals are not routed through the connecting portion 205 including the hinge 201, i.e., a structure in which the flat coaxial cable 34 is combined with the two-shaft hinge mechanism as in the tablet PC 21 described above, the reduction in size and thickness of the apparatus can be achieved and the antennas (main antenna 41A and sub-antenna 42A) can be disposed in the unit (display unit 22) different from the unit in which the radio communication module 83 is disposed.

The embodiments of the present technology are applicable to, in addition to the tablet PC 21 described above, mobile telephones, personal digital assistants (PDA), and other portable information processing apparatus including a substantially plate-like display unit having at least a display and a substantially plate-like main unit having at least a keyboard and used by tilting the display unit and exposing the keyboard (operation buttons).

Embodiments of the present technology are not limited to the embodiments described above and various modifications may be made without departing from the spirit and scope of the present technology.

The present technology can also adopt any one of the following configurations:

(1) An information processing apparatus including:

a substantially plate-like display unit having at least a display;

a substantially plate-like main unit having at least a keyboard;

a connecting plate adapted to connect the display unit and the main unit via hinges; and

a flat coaxial cable including at least one coaxial cable that transmits RF signals between the display unit and the main unit, the at least one coaxial cable being wrapped and shaped flat by a wrapper and secured at predetermined positions in the display unit and the main unit.

(2) The information processing apparatus according to item (1), further including:

a guide plate that serves as a guide to tilt the display unit with respect to the main unit along a certain trajectory.

(3) The information processing apparatus according to item (1) or (2),

wherein the connecting plate has two-shaft hinges including a hinge connected to the display unit and a hinge connected to the main unit.

(4) The information processing apparatus according to any one of items (1) to (3),

wherein the RF signals are radio communication signals.

(5) The information processing apparatus according to any one of items (1) to (4),

wherein the RF signals are wireless LAN signals;

wherein the display unit has a radio communication antenna;

wherein the main unit has a radio communication module that controls radio communications.

(6) The information processing apparatus according to any one of items (1) to (5),

wherein the flat coaxial cable includes two coaxial cables that transmit RF signals.

(7) The information processing apparatus according to item (6),

wherein the display unit has two radio communication antennas connected to the two coaxial cables in a one-to-one relationship.

(8) The information processing apparatus according to item (7),

wherein one of the two radio communication antennas is shared for wireless LAN communications and other radio communications.

(9) The information processing apparatus according to item (7),

wherein the two radio communication antennas simultaneously send or receive two halves of the data to be sent or received.

(10) The information processing apparatus according to any one of items (1) to (9),

wherein the flat coaxial cable further includes one coaxial cable used as a GND wire.

(11) An information processing apparatus including:

a substantially plate-like display unit having at least a display;

a substantially plate-like main unit having at least a keyboard; and

a coaxial cable that transmits RF signals between the display unit and the main unit, the coaxial cable being secured at predetermined positions in the display unit and the main unit without being routed through a connecting portion including hinges that connect the display unit and the main unit.

(12) The information processing apparatus according to item (11), further including:

a connecting plate having two-shaft hinges including a hinge connected to the display unit and a hinge connected to the main unit.

The present disclosure contains subject matter related to that disclosed in Japanese Priority Patent Application JP 2012-184850 filed in the Japan Patent Office on Aug. 24, 2012, the entire contents of which are hereby incorporated by reference.

What is claimed is:

1. An information processing apparatus comprising:
a substantially plate-like display unit having at least a display;
a substantially plate-like main unit having at least a keyboard;
a connecting plate adapted to connect the display unit and the main unit via hinges; and
a flat coaxial cable including at least one coaxial cable that transmits RF signals between the display unit and the main unit, the at least one coaxial cable being wrapped and shaped flat by a wrapper and secured at predetermined positions in the display unit and the main unit.

2. The information processing apparatus according to claim 1, further comprising:
a guide plate that serves as a guide to tilt the display unit with respect to the main unit along a certain trajectory.

3. The information processing apparatus according to claim 1,
wherein the connecting plate has two-shaft hinges including a hinge connected to the display unit and a hinge connected to the main unit.

4. The information processing apparatus according to claim 1,
wherein the RF signals are radio communication signals.

5. The information processing apparatus according to claim 1,
wherein the RF signals are wireless LAN signals;
wherein the display unit has a radio communication antenna;
wherein the main unit has a radio communication module that controls radio communications.

6. The information processing apparatus according to claim 1,
wherein the flat coaxial cable includes two coaxial cables that transmit RF signals.

7. The information processing apparatus according to claim 6,
wherein the display unit has two radio communication antennas connected to the two coaxial cables in a one-to-one relationship.

8. The information processing apparatus according to claim 7,
wherein one of the two radio communication antennas is shared for wireless LAN communications and other radio communications.

9. The information processing apparatus according to claim 7,
wherein the two radio communication antennas simultaneously send or receive two halves of data to be sent or received.

10. The information processing apparatus according to claim 1,
wherein the flat coaxial cable further includes one coaxial cable used as a GND wire.

11. An information processing apparatus comprising:
a substantially plate-like display unit having at least a display;
a substantially plate-like main unit having at least a keyboard; and
a coaxial cable that transmits RF signals between the display unit and the main unit, the coaxial cable being secured at predetermined positions in the display unit and the main unit without being routed through a connecting portion including hinges that connect the display unit and the main unit.

12. The information processing apparatus according to claim 11, further comprising:
a connecting plate having two-shaft hinges including a hinge connected to the display unit and a hinge connected to the main unit.
